(19) United States
(12) Patent Application Publication
(10) Pub. No.: US 2022/0295893 A1
(43) Pub. Date: Sep. 22, 2022

(54) ELECTROMAGNETIC COIL, ELECTROMAGNETIC INDUCTION DEVICE COMPRISING ELECTROMAGNETIC COIL, AND HIGH-FREQUENCY INDUCTION HEATER COMPRISING ELECTROMAGNETIC COIL

(71) Applicant: Shenzhen Eigate Technology Co., Ltd., Shenzhen (CN)

(72) Inventor: Tuanfang LIU, Shenzhen (CN)

(21) Appl. No.: 17/386,505

(22) Filed: Jul. 27, 2021

(30) Foreign Application Priority Data
Mar. 20, 2021 (CN) 202110299139.0
Mar. 20, 2021 (CN) 202120569910.7

(51) Int. Cl. A24F 40/465; H01F 5/00; H05B 6/10; H05B 6/36; A24F 40/20; A24F 40/42

(52) U.S. Cl. CPC A24F 40/465; H01F 5/00; H05B 6/105; H05B 6/36; A24F 40/20; A24F 40/42

(57) ABSTRACT

An electromagnetic coil, including a body including a conductor in the shape of a spiral coil. The cross-sectional area of the conductor is between 3.1 mm² and 320 mm².

### CROSS-REFERENCE TO RELATED APPLICATIONS

Pursuant to 35 U.S.C. § 119 and the Paris Convention Treaty, this application claims foreign priority to Chinese Patent Application No. 202110299139.0 filed Mar. 20, 2021, and to Chinese Patent Application No. 202120569910.7 filed Mar. 20, 2021. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to an electromagnetic coil, an electromagnetic induction device, and a high-frequency induction heater.

Conventionally, when an electromagnetic coil is used to heat flue-cured tobacco by electromagnetic induction, the heating temperature is unstable and the heating power is low, which leads to bad user experience.

### SUMMARY

The disclosure provides an electromagnetic coil, an electromagnetic induction device comprising the electromagnetic coil, and a high-frequency induction heater comprising the electromagnetic coil.

The electromagnetic coil comprises a body comprising a conductor in the shape of a spiral coil. The cross-sectional area of the conductor is 3.1 mm²-320 mm², preferably 3.1 mm²-314 mm², and more preferably 3.8 mm²-314 mm². For example, the cross-sectional area of the conductor may be 3.1 mm², 3.14 mm², 3.3 mm², 3.5 mm², 3.8 mm², 4.2 mm², 4.52 mm², 4.91 mm², 5.31 mm², 6.16 mm², 7.07 mm², 8.04 mm², 9.08 mm², 10.18 mm², 11.34 mm², 12.57 mm², 19.64 mm², 28.27 mm², 50.27 mm², 78.54 mm², 176.72 mm², or 314.16 mm².

In a class of this embodiment, the cross-sectional area of the conductor is 4.9 mm²-79 mm², which improves the efficiency of heating the tobacco material thus improving the taste of the smoke/vapor.

In a class of this embodiment, the cross-sectional area of the conductor is 7 mm²-51 mm², preferably 7 mm²-29 mm², and more preferably 7.07 mm² and 28.3 mm², which improves the efficiency of heating the tobacco material thus improving the taste of the smoke/vapor.

In a class of this embodiment, the cross-sectional area of the conductor is 16.6 mm²-38.5 mm², which improves the efficiency of heating the tobacco material thus improving the taste of the smoke/vapor.

In a class of this embodiment, the cross-sectional shape of the conductor is but not limited to circular, rectangular, elliptical, rhombic, and triangular.

In a class of this embodiment, the conductor includes but is not limited to copper, silver, platinum, and gold. Preferably, the conductor comprises copper or silver, which is cost-effective.

In a class of this embodiment, the outer periphery of the conductor is covered with an insulating layer comprising an insulating material; the insulating material includes, but is not limited to, paint, plastic cement, rubber, plastic, and cotton.

The body is a spiral disc formed by the conductor spiraling in one plane, or is a hollow steric structure formed by the conductor spiraling up along a vertical direction. The spiral disc is similar to a mosquito coil in shape, but is not limited to, a circular disc, an oval disc, a square disc, a triangular disc, a diamond disc, a trapezoidal disc, etc. The shape of the hollow steric structure includes, but is not limited to, a cylinder, a rectangular parallelepiped with unequal length, width and height, a rectangular parallelepiped with a square cross-section, and a cube.

The spiral disc has a diameter of 3 mm-100 mm. For example, the diameter of the spiral disc may be 3 mm, 5 mm, 8 mm, 10 mm, 12 mm, 15 mm, 18 mm, 20 mm, 23 mm, 26 mm, 29 mm, 30 mm, 31 mm, 34 mm, 37 mm, 40 mm, 42 mm, 45 mm, 50 mm, 60 mm, 70 mm, 80 mm, 90 mm, or 100 mm.

The hollow steric structure is a hollow cube having a length, width, and height of 3 mm-100 mm. For example, the hollow cube has a length of 3 mm, 5 mm, 10 mm, 15 mm, 18 mm, 20 mm, 22 mm, 23 mm, 24 mm, 25 mm, 26 mm, 28 mm, 30 mm, 35 mm, 40 mm, 45 mm, 50 mm, 60 mm, 70 mm, 80 mm , 90 mm, or 100 mm; the hollow cube has a width of 3 mm, 5 mm, 10 mm, 15 mm, 18 mm, 20 mm, 22 mm, 23 mm, 24 mm, 25 mm, 26 mm, 28 mm, 30 mm , 35 mm, 40 mm, 45 mm, 50 mm, 60 mm, 70 mm, 80 mm, 90 mm, or 100 mm; and the hollow cube has a height of 3 mm, 5 mm, 10 mm, 12 mm, 15 mm, 16 mm , 17 mm, 18 mm, 18.5 mm, 18.75 mm, 19 mm, 19.5 mm, 20 mm, 22 mm, 25 mm, 30 mm, 35 mm, 40 mm, 45 mm, 50 mm, 60 mm, 70 mm, 80 mm, 90 mm, or 100 mm. The length, width, and height of the hollow cube can be the same or different.

The hollow steric structure is a hollow cylinder having an inner diameter of 3 mm-100 mm and a height of 3 mm-100 mm. The hollow cylinder has an inner diameter of 3 mm, 5 mm, 10 mm, 15 mm, 18 mm, 20 mm, 22 mm, 23 mm, 24 mm, 25 mm, 26 mm, 28 mm, 30 mm, 35 mm, 40 mm, 45 mm, 50 mm, 60 mm, 70 mm, 80 mm, 90 mm, or 100 mm; and the hollow cylinder has a height of 3 mm, 5 mm, 10 mm, 12 mm, 15 mm, 16 mm, 17 mm, 18 mm, 18.5 mm, 18.75 mm, 19 mm, 19.5 mm, 20 mm, 22 mm, 25 mm, 30 mm, 35 mm, 40 mm, 45 mm, 50 mm, 60 mm, 70 mm, 80 mm, 90 mm, or 100 mm.

In a class of this embodiment, the electromagnetic coil is in the shape of the mosquito coil having a diameter of 20 mm-40 mm, and preferably 25 mm-35 mm; or the electromagnetic coil is in the shape of a hollow cube having a length of 15 mm — 30 mm, a width of 15 mm-30 mm, and a height of 10 mm-25 mm; preferably, the hollow cube has a length of 22 mm-26 mm, a width of 22 mm-26 mm, and a height of 16 mm-20 mm; the length, width, and height of the hollow cube can be the same or different; or the electromagnetic coil is in the shape of a hollow cylinder having an inner diameter of 15 mm-30 mm and a height of 10 mm-25 mm; preferably, the hollow cylinder has an inner diameter of 22 mm-26 mm and a height of 16 mm-20 mm.

The conductor comprises two ends, and the two ends are provided with a first connector and a second connector, respectively. The first connector and the second connector are connected to a positive electrode and a negative electrode of a power supply, respectively, so that the electromagnetic coil is electrically connected to the power supply. The first connector and the second connector comprise the same conductive material which is the same as or different from that of the electromagnetic coil. The shape and position of the first connector and the second connector is determined according to needs.

The first connector and the second connector are disposed in a direction parallel to the cross section of the body of the spiral disc.

The conductor comprises 350-9000 conductive wires twisted together. Each of the conductive wires is 0.001 mm-0.2 mm in diameter. Preferably, the conductor comprises 430-480 conductive wires twisted together. Each of the conductive wires is 0.005 mm-0.02 mm in diameter. More preferably, the conductor comprises 430-480 conductive wires twisted together. Each of the conductive wires is 0.007 mm-0.015 mm in diameter. For example, the number of the conductive wires may be 350, 370, 390, 400, 420, 430, 440, 450, 460, 480, 500, 600, 800, 1000, 1500, 2000, 2500, 3000, 4000, 5000, 6000, 7000, 8000, or 9000; the diameter of each conductive wire may be 0.001 mm, 0.003 mm, 0.005 mm, 0.007 mm, 0.008 mm, 0.009 mm, 0.01 mm, 0.011 mm, 0.012 mm, 0.015 mm, 0.017 mm, 0.02 mm, 0.05 mm, 0.07 mm, 0.1 mm, 0.12 mm, 0.15 mm, 0.18 mm, or 0.2 mm.

The number of the circles of the spiral coil of the body is 1-60, preferably 3-10, and more preferably 5-8. For example, the number of the circles of the spiral coil of the body may be 1, 2, 3, 4, 5, 6, 7, 8, 9, 10, 12, 15, 17, 20, 30, 40, 50, or 60. As used herein, the term “number of the circles of the spiral coil of the body” refers to the number of the spiral circles on the same plane or in the vertical direction of the body. The last one circle that is not spiraled into a complete circle is also counted as one circle.

The disclosure further provides an electromagnetic induction device which comprises the aforesaid electromagnetic coil and the power supply for providing an alternating current to the electromagnetic coil.

Further, the disclosure provides a high-frequency induction heater which comprises the electromagnetic coil, the power supply, and a container for holding the smoking material to be heated. The container comprises a metal. In the power on state, the power supply provides an alternating current passing through the electromagnetic coil whereby a magnetic field is generated. The container is heated in the magnetic field. The container may be an all-metal container, or comprises a metal layer disposed inside the wall of the container, on the inner side wall of the container, or the outer side wall of the container.

The body is a hollow steric structure formed by the conductor spiraling up along a vertical direction. The body is disposed around the container. The container is partially or fully disposed in the inner cavity of the body.

The smoking material is tobacco paste or tobacco leaf

In a class of this embodiment, the temperature of the container is up to 100-600° C.

The following advantages are associated with the electromagnetic coil, the electromagnetic induction device, and the high-frequency induction heater of the disclosure: compared with the related art, the electromagnetic coil comprises a small-sized body comprising a conductor with a smaller cross-sectional area, so that the high-frequency induction heater is small and easy to carry. When in use, the electromagnetic coil generates a magnetic field in which the container is heated stably. The tobacco material is heated by electromagnetic induction, and the produced smoke or vapor tastes good, thus improving the user experience.

### BRIEF DESCRIPTION OF THE DRAWINGS

FIG. 1 is a schematic diagram of an electromagnetic coil according to Example 1 of the disclosure.

FIG. 2 is a cross-sectional view of an electromagnetic coil according to Example 1 of the disclosure.

FIG. 3 is an exploded view of a high-frequency induction heater according to Example 1 of the disclosure.

FIG. 4 is a schematic diagram of an electromagnetic coil according to Example 2 of the disclosure.

FIG. 5 is a cross-sectional view of an electromagnetic coil according to Example 2 of the disclosure.

FIG. 6 is an exploded view of a high-frequency induction heater according to Example 2 of the disclosure.

FIG. 7 is a schematic diagram of an electromagnetic coil according to Example 3 of the disclosure.

FIG. 8 is a cross-sectional view of an electromagnetic coil according to Example 3 of the disclosure.

FIG. 9 is an exploded view of a high-frequency induction heater according to Example 3 of the disclosure.

In the drawings, the following reference numbers are used: 1. Electromagnetic coil; 2. Container; 3. Power supply; 10. Body; 11. First connector; 12. Second connector; and 101. Cross-sectional area.

### DETAILED DESCRIPTION

To further illustrate, embodiments detailing an electromagnetic induction device comprising the electromagnetic coil, and a high-frequency induction heater comprising the electromagnetic coil are described below. It should be noted that the following embodiments are intended to describe and not to limit the disclosure.

Principle of high frequency heating: when an alternating current is introduced to a magnetic induction coil, an alternating magnetic field will be generated. When a metal conductor is placed in the alternating magnetic field, an eddy current is produced. The eddy current makes the metal conductor heated.

The term “smoking material” as used herein refers to tobacco tar, tobacco paste, tobacco leaf, e-liquid, nicotine-containing natural components, nicotine-containing artificial components, or aromas (such as peppermint oil, essential oils, etc.), which is heated to produce an aerosol similar to the smoke.

### EXAMPLE 1

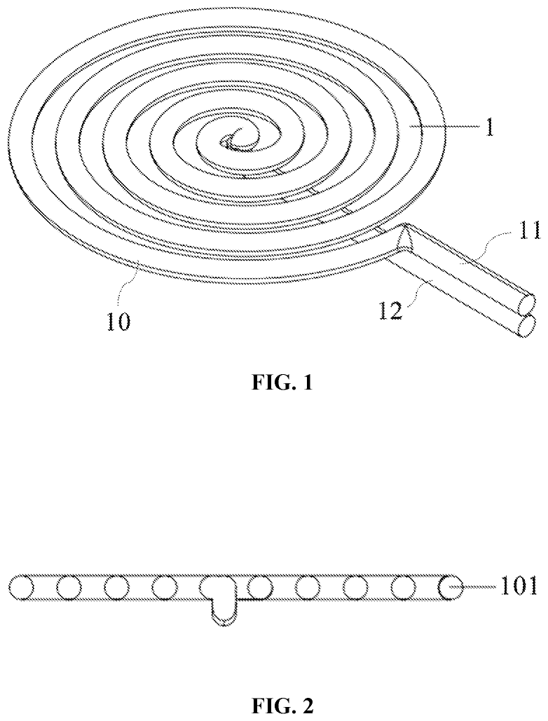

Referring to FIGS. 1-2, an electromagnetic coil 1 comprises a body 10 comprising a conductor in the shape of a spiral coil. Preferably, the conductor has a cross-sectional area 101 of 7.07 mm². The body 10 has a diameter of 30 mm and the number of the circles of the spiral coil is 6. The conductor comprises 450 conductive wires twisted together. Each of the 450 conductive wires is 0.1 mm in diameter. Preferably, the conductor comprises copper.

The conductor comprises two ends, and the two ends are provided with a first connector 11 and a second connector 12, respectively. The first connector 11 and the second connector 12 are disposed in a direction parallel to the cross section of the body 10 of the spiral disc.

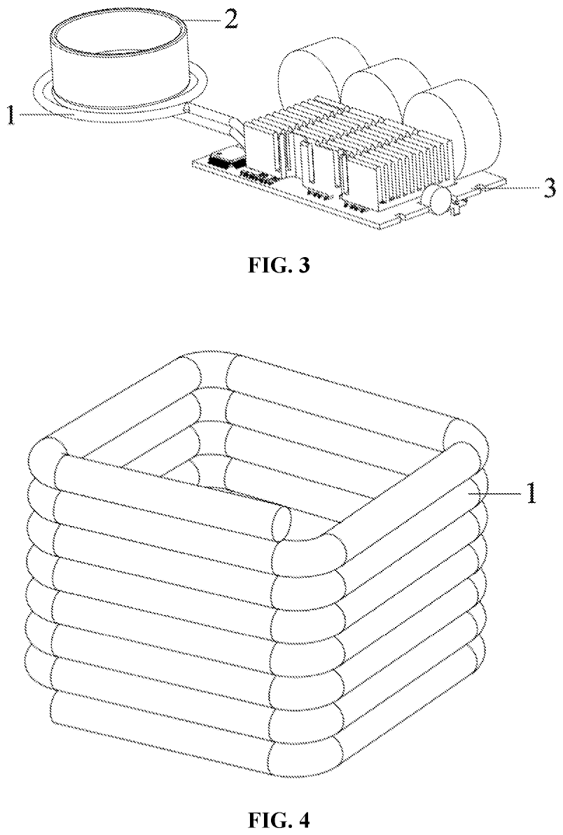

Referring to FIG. 3, a power supply 3 comprises an output terminal connected to the electromagnetic coil 1. In the power on state, the power supply 3 provides an alternating current passing through the electromagnetic coil 1 to generate a magnetic field. A container 2 comprises a metal, is used to hold a tobacco material, and is disposed on the surface of the electromagnetic coil 1. The container 2 is heated in the magnetic field produced by the electromagnetic coil 1 and the tobacco material in the container 2 is heated and burned to produce smoke.

In Example 1, the electromagnetic coil 1 of different configurations are supplied with alternating current of the same frequency to heat the same container. Referring to Table 1, the results show that the users have better smoking experience when the cross-sectional area of the conductor is 7 mm² -51 mm², have the best smoking experience when the cross-sectional area of the conductor is 16.6 mm² -38.5 mm², and have normal smoking experience when the cross-sectional area of the conductor is 4.9 mm²-79 mm². When the cross-sectional area of the conductor is smaller than 3.1 mm², the tobacco material burns with a small amount of smoke produced and has a mild tobacco flavor. When the cross-sectional area of the conductor is greater than 320 mm², the tobacco material burns at a high heating power, resulting in a burnt taste and the smoking experience is bad.

TABLE 1

| | Conductive | Cross-sectional | Amount of | |
|---|---|---|---|---|
| Example | material | area of conductor (mm²) | smoke produced | Taste |
| 1 | Copper | 2.5 | + | Small amount of |
| | | | | smoke, mild |
| | | | | flavor, slight |
| | | | | original taste |
| 2 | | 3.0 | ++ | Small amount of |
| | | | | smoke, mild |
| | | | | flavor, slight |
| | | | | original taste |
| 3 | | 3.1 | +++ | Low mouthfeel, |
| | | | | moderate |
| | | | | original taste |
| 4 | | 3.8 | ++++ | Low mouthfeel, |
| | | | | moderate |
| | | | | original taste |
| 5 | | 4.9 | ++++ | Medium |
| | | | | mouthfeel, |
| | | | | considerable |
| | | | | original taste |
| 6 | | 7 | ++++++ | High mouthfeel, |
| | | | | good taste |
| 7 | | 16.6 | +++++++ | High mouthfeel, |
| | | | | good taste |
| 8 | | 38.5 | +++++++ | High mouthfeel, |
| | | | | good taste |
| 9 | | 51 | ++++++++ | High mouthfeel, |
| | | | | good taste |
| 10 | | 79 | +++++++++ | High mouthfeel, |
| | | | | good taste |
| 11 | | 314 | +++++++++ | Burnt taste |
| 12 | Silver | 2.5 | + | Small amount of |
| | | | | smoke, mild |
| | | | | flavor, slight |
| | | | | original taste |
| 13 | | 3.0 | ++ | Small amount of |
| | | | | smoke, mild |
| | | | | flavor, slight |
| | | | | original taste |
| 14 | | 3.1 | +++ | Low mouthfeel, |
| | | | | moderate |
| | | | | original taste |
| 15 | | 3.8 | ++++ | Low mouthfeel, |
| | | | | moderate |
| | | | | original taste |
| 16 | | 4.9 | ++++ | Medium |
| | | | | mouthfeel, |
| | | | | considerable |
| | | | | original taste |
| 17 | | 7 | ++++++ | High mouthfeel, |
| | | | | good taste |
| 18 | | 16.6 | ++++++ | High mouthfeel, |
| | | | | good taste |
| 19 | | 38.5 | +++++++ | High mouthfeel, |
| | | | | good taste |
| 20 | | 51 | ++++++++ | High mouthfeel, |
| | | | | good taste |
| 21 | | 79 | +++++++++ | High mouthfeel, |
| | | | | good taste |
| 22 | | 314 | +++++++++ | Burnt taste |

### EXAMPLE 2

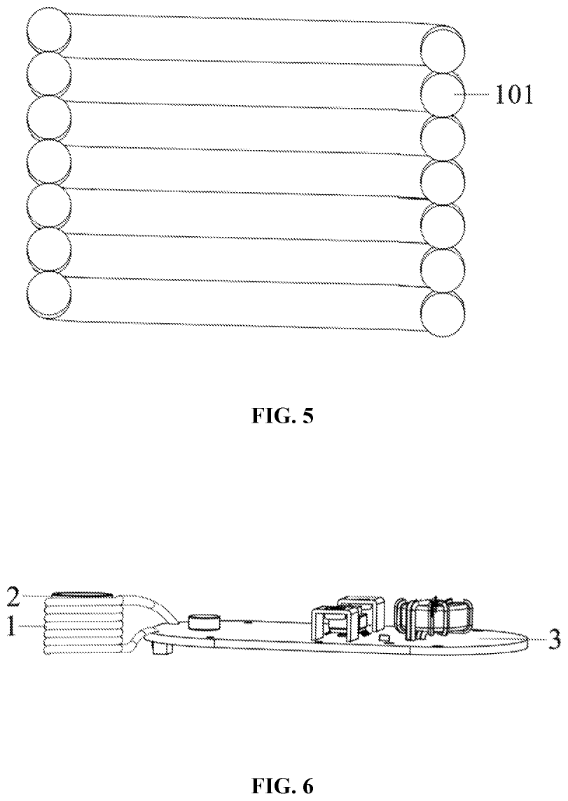

Referring to FIGS. 4-5, an electromagnetic coil 1 comprises a body 10 which is a hollow cubic structure formed by a conductor spiraling up along the vertical direction of the body. Preferably, the cross-sectional area 101 of the conductor is 7.07 mm². The hollow steric structure has a length of 24 mm, a height of 18.75 mm, and 6 circles of the spiral coil. The conductor comprises 450 conductive wires twisted together. Each of the 450 conductive wires is 0.01 mm in diameter. Preferably, the conductor comprises copper.

Referring to FIG. 6, a power supply 3 comprises an output terminal connected to the electromagnetic coil 1. In the power on state, the power supply 3 provides an alternating current passing through the electromagnetic coil 1 to generate a magnetic field. A container 2 comprises a metal, is used to hold a tobacco material, and is disposed on the surface of the electromagnetic coil 1. The container 2 is heated in the magnetic field produced by the electromagnetic coil 1 and the tobacco material in the container 2 is heated and burned to produce smoke.

In Example 2, the electromagnetic coil 1 of different configurations are supplied with alternating current of the same frequency to heat the same container. Referring to Table 2, the results show that the users have better smoking experience when the cross-sectional area of the conductor is 7 mm² -51 mm², have the best smoking experience when the cross-sectional area of the conductor is 16.6 mm² -38.5 mm², and have normal smoking experience when the cross-sectional area of the conductor is 4.9 mm²-79 mm². When the cross-sectional area of the conductor is smaller than 3.1 mm², the tobacco material burns with a small amount of smoke produced and has a mild tobacco flavor. When the cross-sectional area of the conductor is greater than 320 mm², the tobacco material burns at a high heating power, resulting in a burnt taste and the user experience is bad.

TABLE 2

| | Conductive | Cross-sectional | Amount of smoke | |
|---|---|---|---|---|
| Example | material | area of conductor (mm²) | produced | Taste |
| 1 | Copper | 2.5 | + | Small amount |
| | | | | of smoke, mild |
| | | | | flavor, slight |
| | | | | original taste |
| 2 | | 3.0 | ++ | Small amount |
| | | | | of smoke, mild |
| | | | | flavor, slight |
| | | | | original taste |
| 3 | | 3.1 | +++ | Low mouthfeel, |
| | | | | moderate |
| | | | | original taste |
| 4 | | 3.8 | ++++ | Low mouthfeel, |
| | | | | moderate |
| | | | | original taste |
| 5 | | 4.9 | ++++ | Medium |
| | | | | mouthfeel, |
| | | | | considerable |
| | | | | original taste |
| 6 | | 7 | ++++++ | High |
| | | | | mouthfeel, |
| | | | | good taste |
| 7 | | 16.6 | +++++++ | High |
| | | | | mouthfeel, |
| | | | | good taste |
| 8 | | 38.5 | +++++++ | High |
| | | | | mouthfeel, |
| | | | | good taste |
| 9 | | 51 | ++++++++ | High |
| | | | | mouthfeel, |
| | | | | good taste |
| 10 | | 79 | +++++++++ | High |
| | | | | mouthfeel, |
| | | | | good taste |
| 11 | | 314 | +++++++++ | Burnt taste |
| 12 | Silver | 2.5 | + | Small amount |
| | | | | of smoke, mild |
| | | | | flavor, slight |
| | | | | original taste |
| 13 | | 3.0 | ++ | Small amount |
| | | | | of smoke, mild |
| | | | | flavor, slight |
| | | | | original taste |
| 14 | | 3.1 | +++ | Low mouthfeel, |
| | | | | moderate |
| | | | | original taste |
| 15 | | 3.8 | ++++ | Low mouthfeel, |
| | | | | moderate |
| | | | | original taste |
| 16 | | 4.9 | ++++ | Medium |
| | | | | mouthfeel, |
| | | | | considerable |
| | | | | original taste |
| 17 | | 7 | ++++++ | High |
| | | | | mouthfeel, |
| | | | | good taste |
| 18 | | 16.6 | ++++++ | High |
| | | | | mouthfeel, |
| | | | | good taste |
| 19 | | 38.5 | +++++++ | High |
| | | | | mouthfeel, |
| | | | | good taste |
| 20 | | 51 | ++++++++ | High |
| | | | | mouthfeel, |
| | | | | good taste |
| 21 | | 79 | +++++++++ | High |
| | | | | mouthfeel, |
| | | | | good taste |
| 22 | | 314 | +++++++++ | Burnt taste |

### EXAMPLE 3

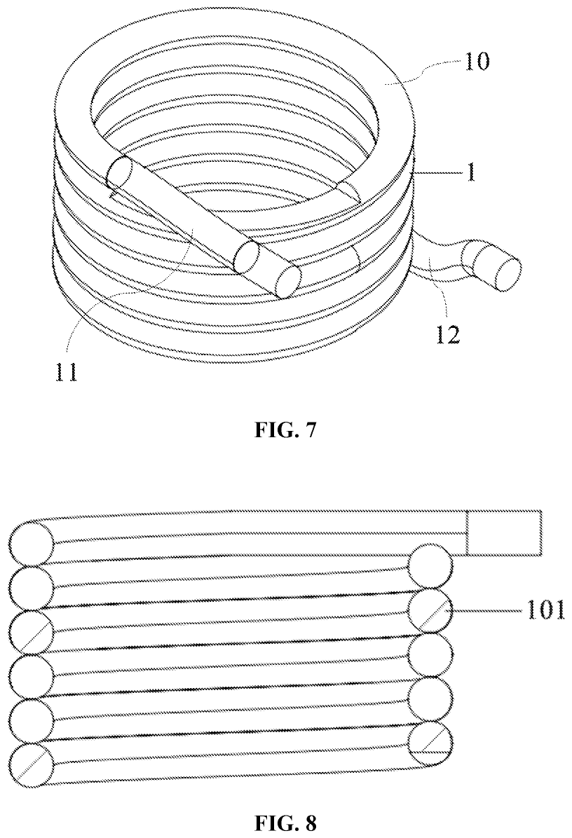

Referring to FIGS. 7-8, an electromagnetic coil 1 comprises a body 10 which is a hollow cylinder formed by a conductor spiraling up along the vertical direction of the body. Preferably, the cross-sectional area of the conductor is 28.3 mm². The hollow cylinder has an inner diameter of 24 mm, a height of 18.75 mm, and 6 circles of the spiral coil. The conductor comprises 450 conductive wires twisted together. Each of the 450 conductive wires is 0.1 mm in diameter. Preferably, the conductor comprises copper.

The conductor comprises two ends, and the two ends are provided with a first connector 11 and a second connector 12, respectively. The first connector 11 and the second connector 12 are disposed in a direction parallel to the spiral.

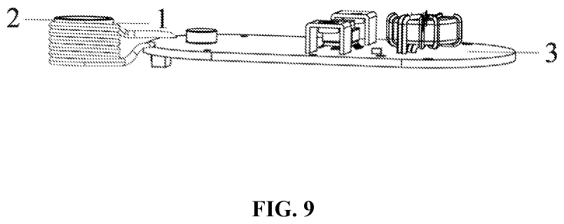

Referring to FIG. 9, a power supply 3 comprises an output terminal connected to the electromagnetic coil 1. In the power on state, the power supply 3 provides an alternating current passing through the electromagnetic coil 1 to generate a magnetic field. A container 2 comprises a metal, is used to hold a tobacco material, and is disposed on the surface of the electromagnetic coil 1. The container 2 is heated in the magnetic field produced by the electromagnetic coil 1 and the tobacco material in the container 2 is heated and burned to produce smoke.

In Example 3, the electromagnetic coil 1 of different configurations are supplied with alternating current of the same frequency to heat the same container. Referring to Table 3, the results show that the users have better smoking experience when the cross-sectional area of the conductor is 7 mm² -51 mm², have the best smoking experience when the cross-sectional area of the conductor is 16.6 mm² -38.5 mm², and have normal smoking experience when the cross-sectional area of the conductor is 4.9 mm²-79 mm². When the cross-sectional area of the conductor is smaller than 3.1 mm², the tobacco material burns with a small amount of smoke produced and has a mild tobacco flavor. When the cross-sectional area of the conductor is greater than 320 mm², the tobacco material burns at a high heating power, resulting in a burnt taste and the user experience is bad.

TABLE 3

| | Conductive | Cross-sectional | Amount of smoke | |
|---|---|---|---|---|
| Example | material | area of conductor(mm²) | produced | Taste |
| 1 | Copper | 2.5 | + | Small amount |
| | | | | of smoke, mild |
| | | | | flavor, slight |
| | | | | original taste |
| 2 | | 3.0 | ++ | Small amount |
| | | | | of smoke, mild |
| | | | | flavor, slight |
| | | | | original taste |
| 3 | | 3.1 | +++ | Low |
| | | | | mouthfeel, |
| | | | | moderate |
| | | | | original taste |
| 4 | | 3.8 | ++++ | Low |
| | | | | mouthfeel, |
| | | | | moderate |
| | | | | original taste |
| 5 | | 4.9 | ++++ | Medium |
| | | | | mouthfeel, |
| | | | | considerable |
| | | | | original taste |
| 6 | | 7 | ++++++ | High |
| | | | | mouthfeel, |
| | | | | good taste |
| 7 | | 16.6 | +++++++ | High |
| | | | | mouthfeel, |
| | | | | good taste |
| 8 | | 38.5 | +++++++ | High |
| | | | | mouthfeel, |
| | | | | good taste |
| 9 | | 51 | ++++++++ | High |
| | | | | mouthfeel, |
| | | | | good taste |
| 10 | | 79 | +++++++++ | High |
| | | | | mouthfeel, |
| | | | | good taste |
| 11 | | 314 | +++++++++ | Burnt taste |
| 12 | Silver | 2.5 | + | Small amount |
| | | | | of smoke, mild |
| | | | | flavor, slight |
| | | | | original taste |
| 13 | | 3.0 | ++ | Small amount |
| | | | | of smoke, mild |
| | | | | flavor, slight |
| | | | | original taste |
| 14 | | 3.1 | +++ | Low |
| | | | | mouthfeel, |
| | | | | moderate |
| | | | | original taste |
| 15 | | 3.8 | ++++ | Low |
| | | | | mouthfeel, |
| | | | | moderate |
| | | | | original taste |
| 16 | | 4.9 | ++++ | Medium |
| | | | | mouthfeel, |
| | | | | considerable |
| | | | | original taste |
| 17 | | 7 | ++++++ | High |
| | | | | mouthfeel, |
| | | | | good taste |
| 18 | | 16.6 | ++++++ | High |
| | | | | mouthfeel, |
| | | | | good taste |
| 19 | | 38.5 | +++++++ | High |
| | | | | mouthfeel, |
| | | | | good taste |
| 20 | | 51 | ++++++++ | High |
| | | | | mouthfeel, |
| | | | | good taste |
| 21 | | 79 | +++++++++ | High |
| | | | | mouthfeel, |
| | | | | good taste |
| 22 | | 314 | +++++++++ | Burnt taste |

Note that the more “+” in Tables 1-3, the greater the amount of the smoke produced. Mouthfeel sensory evaluation: high mouthfeel>medium mouthfeel>low mouthfeel.

It will be obvious to those skilled in the art that changes and modifications may be made, and therefore, the aim in the appended claims is to cover all such changes and modifications.

What is claimed is:

1. An electromagnetic coil, comprising a body comprising a conductor in the shape of a spiral coil, wherein a cross-sectional area of the conductor is between 3.1 mm² and 320 mm².

2. The electromagnetic coil of claim 1, wherein the cross-sectional area of the conductor is between 4.9 mm² and 79 mm².

3. The electromagnetic coil of claim 2, wherein the cross-sectional area of the conductor is between 7 mm² and 51 mm².

4. The electromagnetic coil of claim 3, wherein the cross-sectional area of the conductor is between 16.6 mm² and 38.5 mm².

5. The electromagnetic coil of claim 4, wherein a cross-sectional shape of the conductor is circular, rectangular, elliptical, rhombic, or triangular; and/or an outer periphery of the conductor is covered with an insulating layer.

6. The electromagnetic coil of claim 4, wherein the body is a spiral disc formed by the conductor spiraling in one plane, or is a hollow steric structure formed by the conductor spiraling up along a vertical direction of the body.

7. The electromagnetic coil of claim 6, wherein the spiral disc has a diameter of 3 mm-100 mm; or the hollow steric structure is a hollow cube having a length, width, and height of 3 mm-100 mm; or the hollow steric structure is a hollow cylinder having an inner diameter of 3 mm-100 mm and a height of 3 mm-100 mm.

8. The electromagnetic coil of claim 7, wherein the spiral disc has a diameter of 20 mm-40 mm; or the hollow steric structure is a hollow cube having a length of 15 mm-30 mm, a width of 15 mm-30 mm, and a height of 10 mm — 25 mm; or the hollow steric structure is a hollow cylinder having an inner diameter of 15 mm-30 mm and a height of 10 mm-25 mm.

9. The electromagnetic coil of claim 1, wherein the conductor comprises 350-9000 conductive wires twisted together; and each of the conductive wires is 0.001 mm-0.2 mm in diameter.

10. The electromagnetic coil of claim 6, wherein a number of circles of the spiral coil of the body is 1-60.

11. The electromagnetic coil of claim 1, wherein the conductor comprises copper, silver, platinum, or gold.

12. An electromagnetic induction device, comprising the electromagnetic coil of claim 1 and a power supply for providing an alternating current to the electromagnetic coil.

13. A high-frequency induction heater, comprising the electromagnetic coil of claim 1, a power supply for providing an alternating current to the electromagnetic coil, and a container for holding a smoking material to be heated; wherein the container comprises a metal; in a power on state, the power supply provides an alternating current passing through the electromagnetic coil whereby a magnetic field is generated; and the container is heated in the magnetic field.

14. The high-frequency induction heater of claim 13, wherein the body is a hollow steric structure formed by the conductor spiraling up along a vertical direction of the body; the body is disposed around the container; and the container is partially or fully disposed in an inner cavity of the body.

15. The high-frequency induction heater of claim 13, wherein the smoking material is tobacco paste or tobacco leaf.
